(19) United States
(12) Patent Application Publication
(10) Pub. No.: US 2015/0294083 A1
(43) Pub. Date: Oct. 15, 2015

(54) INFORMATION PROCESSING APPARATUS, INFORMATION PROCESSING METHOD, AND PROGRAM

(71) Applicant: CANON KABUSHIKI KAISHA, Tokyo (JP)

(72) Inventor: Anna Yokokubo, Tokyo (JP)

(21) Appl. No.: 14/677,749

(22) Filed: Apr. 2, 2015

(30) Foreign Application Priority Data
Apr. 9, 2014 (JP) 2014-080370

(51) Int. Cl. G06F 19/00

(52) U.S. Cl. CPC G06F 19/3443; G06F 19/363; G06F 19/3456

(57) ABSTRACT

An information processing apparatus includes a first acquisition unit configured to acquire medical information of a patient, a second acquisition unit configured to acquire medical information of the patient's blood relatives, a determination unit configured to determine a degree of association between the patient's symptoms and the patient's family medical history based on the patient's medical information acquired by the first acquisition unit and the medical information of the patient's blood relatives acquired by the second acquisition unit, and a display control unit configured to display a family medical history on a display unit based on the degree of association determined by the determination unit.

### BACKGROUND OF THE INVENTION

1. Field of the Invention

The present invention relates to a technique for an information processing apparatus, an information processing method, and a program.

2. Description of the Related Art

Recent medical scenes have seen a progress in personalized medical care for providing medical services which best suit the individuality of each person. In personalized medical care, medical treatments are performed based on individual medical information, for example, by utilizing patient's genes. Accordingly, medical actions more suitable for each individual patient is expected. In recent years, importance is attached to medical care for improving a convincing and satisfying degree of patients.

In a medical scene, a medical interview is performed as a medical action for grasping situations of a patient. In the medical interview, a medical staff tries to obtain the patient's image, asks about main symptoms, present clinical history, previous history, and family medical history of the patient, and describes these pieces of information in a medical record.

However, during a medical interview in the present medical scenes, a means for confirming patient information including the patient's family medical history is limited to a dialog between the medical staff and the patient. Therefore, there are often cases where the patient fails to inform the medical staff of patient information, and where the medical staff fails to ask the patient some questions, resulting in failure to record all necessary information. Further, if the patient does not correctly grasp the family medical history or if the frequency of medical interviews is low, it is difficult to acquire the sufficient patient information only through conventional medical interviews. As a result, patient information necessary to perform accurate diagnosis is insufficient.

Therefore, if the medical staff does not have full knowledge of the patient information including the family medical history, medical treatments for genetic diseases (such as hemophilia) and constitutional diseases (such as diabetes and hypertension) for which the family medical history is important, may possibly be delayed.

To solve such a problem, a method for presenting the patient information is currently being studied.

In many medical fronts, with the increase in the use of medical information systems, such as a Hospital Information System (HIS), a Picture Archiving and Communication System (PACS), and a Radiology Information System (RIS), medical images and documents are currently being computerized.

According to a technique discussed in Japanese Patent Application Laid-Open No. 2007-328740, a medical interview sheet (which has been conventionally described on paper) is computerized and interview results are automatically generated by utilizing the medical information such as inspection data of each patient. Further, the technique discussed in Japanese Patent Application Laid-Open No. 2007-328740 generates interview results with reference to a family medical history with reference to the medical information of the patient's blood relatives.

A technique discussed in Japanese Patent Application Laid-Open No. 2002-269226 records not only a patient file (describing patient's name, age, major complaints, etc.) but also patient's allergosis information, a previous disease, and a family medical history as special affairs, and provide these pieces of information for reference at the time of medical examination.

However, to improve working efficiency of doctors and other medical staffs, it is necessary to utilize patient information including the family medical history in a more effective way.

### SUMMARY OF THE INVENTION

According to an aspect of the present invention, an information processing apparatus includes a first acquisition unit configured to acquire medical information of a patient, a second acquisition unit configured to acquire medical information of the patient's blood relatives, a determination unit configured to determine a degree of association between the patient's symptoms and the patient's family medical history based on the patient's medical information acquired by the first acquisition unit and on the medical information of the patient's blood relatives acquired by the second acquisition unit, and a display control unit configured to display the family medical history on a display unit based on the degree of association determined by the determination unit.

Further features of the present invention will become apparent from the following description of exemplary embodiments with reference to the attached drawings.

### BRIEF DESCRIPTION OF THE DRAWINGS

FIG. 1 schematically illustrates an example of a configuration of a medical information system.

FIG. 2 illustrates an example of a functional configuration of a medical information analysis processing unit.

FIG. 3 is a flowchart illustrating information processing by the medical information analysis processing unit.

FIG. 4 is a flowchart illustrating processing in step S301.

FIG. 5 is a flowchart illustrating processing in step S302.

FIG. 6 illustrates a patient's genealogy.

FIGS. 7A and 7B illustrate an example of medical information extraction processing.

FIG. 8 (including FIGS. 8A and 8B) is a flowchart illustrating processing in step S303.

FIG. 9 illustrates an example of association of family medical history.

FIG. 10 is a flowchart illustrating processing in step S304.

FIG. 11 illustrates an example of a screen for displaying results of analysis by the medical information analysis processing unit.

FIG. 12 (including FIGS. 12A and 12B) is a flowchart illustrating processing in step S303.

FIG. 13 illustrates an example of a screen for displaying results of analysis by the medical information analysis processing unit.

FIG. 14 is a flowchart illustrating processing in step S303.

FIG. 15 illustrates an example of a screen for displaying results of analysis by the medical information analysis processing unit.

### DESCRIPTION OF THE EMBODIMENTS

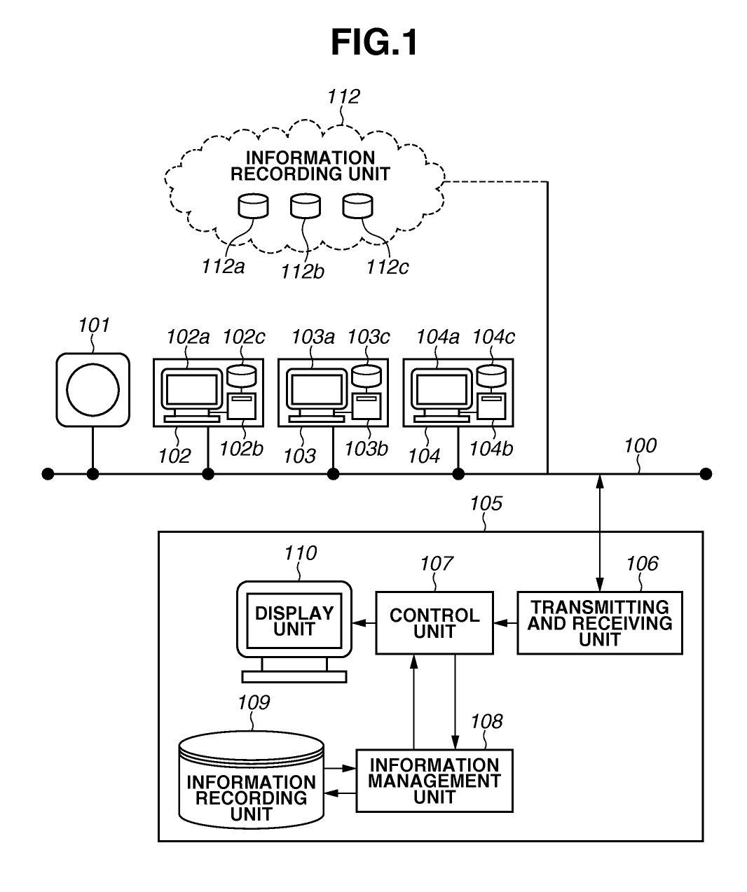

A first exemplary embodiment will be described below. FIG. 1 schematically illustrates an example of a configuration of a medical information system including a medical information analysis processing unit.

Referring to FIG. 1, a modality 101, an intra-hospital system (including an HIS 102, an RIS 103, a PACS 104, and a medical information analysis processing apparatus 105), and an information recording unit (a cloud 112) are connected to a network 100 to enable communicating with each other.

The modality 101 captures images of a subject's region to be inspected to generate two- or three-dimensional image data of the region. The medical information system includes an apparatus for adding incidental information prescribed by the Digital Imaging and Communication in Medicine (DICOM) standard to the image data, and outputting resultant image information. The image data may include text information which accompanies an image. Captured medical images are transmitted to the HIS 102, the RIS 103, and the PACS 104 via the network 100.

The HIS 102 includes an HIS information display unit 102a, an HIS information control unit 102b, and an HIS information recording unit 102c. HIS information may be stored in an HIS information recording unit 112a in the cloud 112 in addition to the HIS information recording unit 102c.

The HIS information recording unit 102c and the HIS information recording unit 112a in the cloud 112 store patient's personal information and personal information of the patient's blood relatives, including name, gender, age, height, weight, and nationality. The HIS information recording unit 102c and the HIS information recording unit 112a further store the patient's medical information and the medical information of the patient's blood relatives. The patient's medical information includes patient's medical conditions, a previous history, inspection results, diagnostic results, radiogram interpretation reports, and medical images. The medical information of the patient's blood relatives includes conditions about patient's blood relatives, previous history (family medical history), inspection results, diagnostic results, radiogram interpretation reports, and medical images. A genealogy can be registered in the information about the patient and patient's blood relatives to record a relation between the patient and the patient's blood relatives. Thus, the HIS information recording unit 102c and the HIS information recording unit 112a in the cloud 112 store overall intra-hospital information regarding patients and their blood relatives.

The HIS information control unit 102b may be implemented in the HIS 102 as hardware or as software. When the HIS information control unit 102b is implemented as software, the HIS 102 includes at least a central processing unit (CPU) and a memory as hardware. When the CPU executes processing based on a program stored in the memory, the HIS information control unit 102b functions as software. The HIS information control unit 102b controls the HIS information display unit 102a and the HIS information recording unit 102c. For example, in response to a request from the medical information analysis processing apparatus 105 (described below), the HIS information control unit 102b transmits information recorded in the HIS information recording unit 102c to the medical information analysis processing apparatus 105.

The RIS 103 includes an RIS information display unit 103a, an RIS information control unit 103b, and an RIS information recording unit 103c. RIS information may be stored in the RIS information recording unit 112b in the cloud 112 in addition to the RIS information recording unit 103c.

The RIS information recording unit 103c and the RIS information recording unit 112b in the cloud 112 store inspection results and medical treatment records related to non-radiation apparatuses, such as an ultrasonic apparatuses, an endoscope, and a fundus apparatus, and overall information regarding inspection reservation.

The RIS information control unit 103b may be implemented in the RIS 103 as hardware or as software. When the RIS information control unit 103b is implemented as software, the RIS 103 includes at least a CPU and a memory as hardware. When the CPU executes processing based on a program stored in the memory, the RIS information control unit 103b functions as software. The RIS information control unit 103b controls the RIS information display unit 103a and the RIS information recording unit 103c. For example, in response to a request from the medical information analysis processing apparatus 105 (described below), the RIS information control unit 103b transmits information recorded in the RIS information recording unit 103c to the medical information analysis processing apparatus 105.

The PACS 104 includes a PACS information display unit 104a, a PACS information control unit 104b, and a PACS information recording unit 104c. PACS information may be stored in the PACS information recording unit 112c in the cloud 112 in addition to the PACS information recording unit 104c.

The PACS information recording unit 104c and the PACS information recording unit 112c in the cloud 112 store medical images and accompanied information. As accompanied information, the PACS information recording unit 104c and the PACS information recording unit 112c store overall information regarding medical images, such as image identifier (ID) for identifying each individual image, the patient's ID for identifying a subject, date of inspection, and time of inspection. When a radiogram interpretation report is generated, the PACS information recording unit 104c and the PACS information recording unit 112c further store overall information regarding radiogram interpretation, such as x-ray analyst name, radiogram interpretation image, and medical view as accompanied information.

The PACS information control unit 104b may be implemented in the PACS 104 as hardware or as software. When the PACS information control unit 104b is implemented as software, the PACS 104 includes at least a CPU and a memory as hardware. When the CPU executes processing based on a program stored in the memory, the PACS information control unit 104b functions as software. The PACS information control unit 104b controls the PACS information display unit 104a and the PACS information recording unit 104c. For example, in response to a request from the medical information analysis processing apparatus 105 (described below), the PACS information control unit 104b transmits information recorded in the PACS information recording unit 104c to the medical information analysis processing apparatus 105.

The medical information analysis processing apparatus 105 includes a transmitting and receiving unit 106, a control unit 107, an information management unit 108, an information recording unit 109, and a display unit 110.

The transmitting and receiving unit 106, the control unit 107, and the information management unit 108 may be implemented in the medical information analysis processing apparatus 105 as hardware or as software. When the transmitting and receiving unit 106, the control unit 107, and the information management unit 108 are implemented as software, the medical information analysis processing apparatus 105 includes at least a CPU and a memory as hardware. When the CPU executes processing based on a program stored in the memory, the transmitting and receiving unit 106, the control unit 107, and the information management unit 108 function as software.

The cloud 112 is a system to which a plurality of computers is connected via a network. The cloud 112 provides other apparatuses with web services (services related to information storage in the present exemplary embodiment) via the network 100. The information recording unit 109 may be included in the cloud 112.

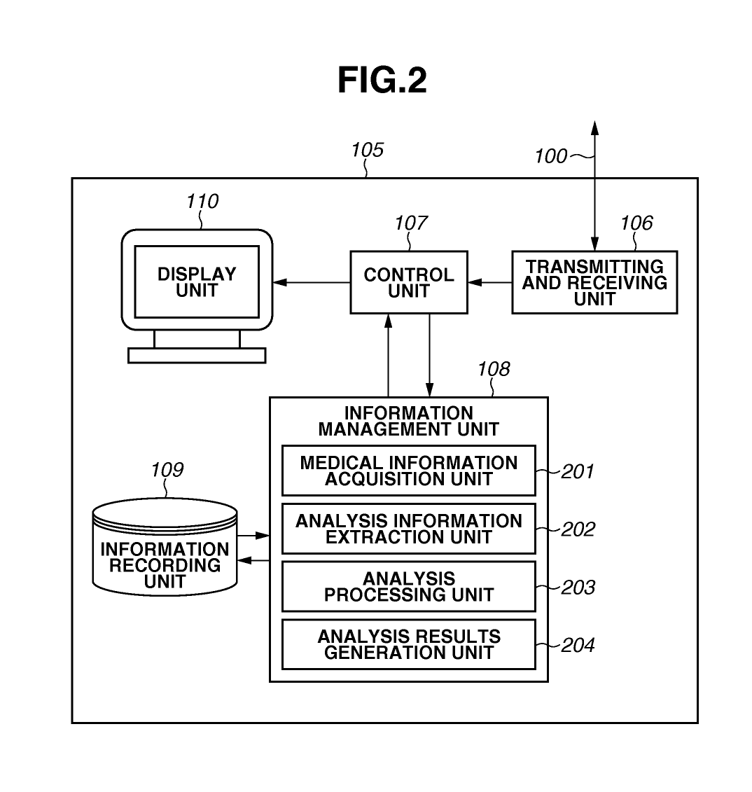

FIG. 2 illustrates an example of a functional configuration of the medical information analysis processing unit 105.

Referring to FIG. 2, the medical information analysis processing apparatus 105 includes the transmitting and receiving unit 106, the control unit 107, the information management unit 108, the information recording unit 109, and the display unit 110.

The control unit 107 controls the entire medical information analysis processing apparatus 105. The control unit 107 controls the display unit 110 to display information based on information from the information management unit 108.

The information management unit 108 includes a medical information acquisition unit 201, an analysis information extraction unit 202, an analysis processing unit 203, and an analysis results generation unit 204. The medical information acquisition unit 201 acquires the patient's medical information included in the HIS 102, the RIS 103, the PACS 104, etc. via the transmitting and receiving unit 106 connected to the network 100. For example, the medical information acquisition unit 201 acquires information from the HIS information recording unit 102c, the RIS information recording unit 103c, and the PACS information recording unit 104c. The medical information acquisition unit 201 may acquire information from the HIS information recording unit 112a, the RIS information recording unit 112b, and the PACS information recording unit 112c in the cloud 112.

The analysis information extraction unit 202 extracts a part of the medical information of the patient's blood relatives from the acquired medical information. The analysis processing unit 203 performs analysis processing on a combination of closely related information out of the patient's medical information and the medical information of the patient's blood relatives acquired by the medical information acquisition unit 201. The analysis results generation unit 204 converts the result of the analysis by the analysis processing unit 203 into a visual format which can be easily recognized.

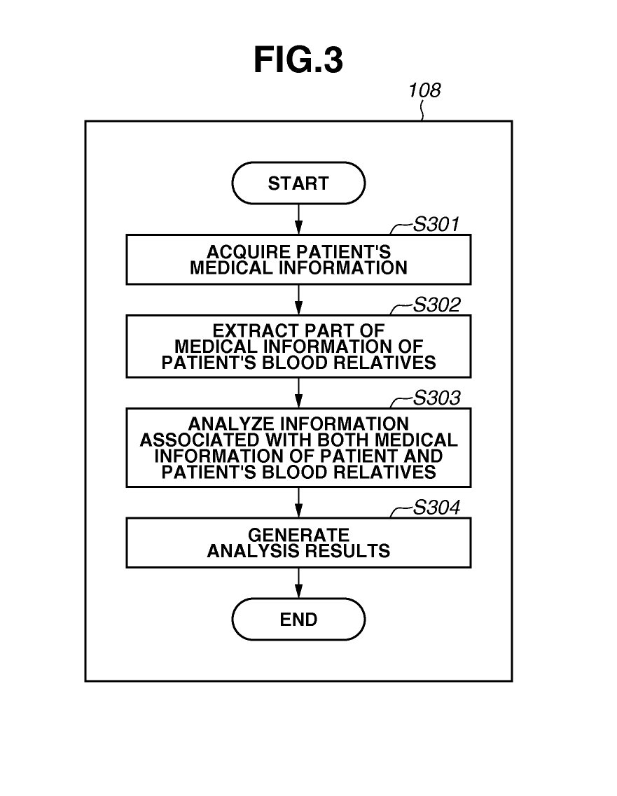

FIG. 3 is a flowchart illustrating information processing performed by the medical information analysis processing unit 105.

Referring to FIG. 3, the information management unit 108 included in the medical information analysis processing apparatus 105 performs the following processing.

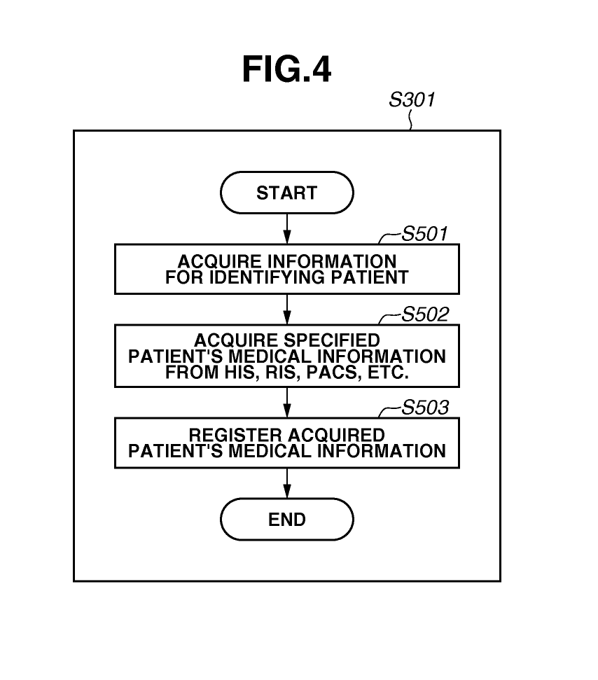

In step S301, the information management unit 108 acquires the patient's medical information included in the HIS 102, the RIS 103, and the PACS 104 via the network 100. Processing in step S301 will be described in detail below with reference to FIG. 4. Step S301 is executed, for example, when a doctor inputs an instruction for displaying patient information of a selected patient via an instruction unit (not illustrated).

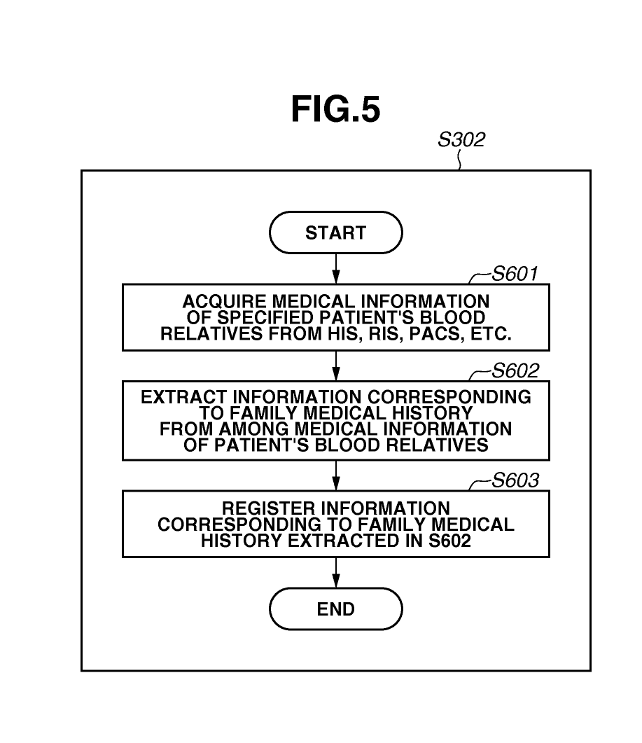

In step S302, the information management unit 108 automatically extracts portions corresponding to the patient's family medical history as a part of the medical information of the patient's blood relatives, from the acquired medical information. Processing in step S302 will be described in detail below with reference to FIG. 5.

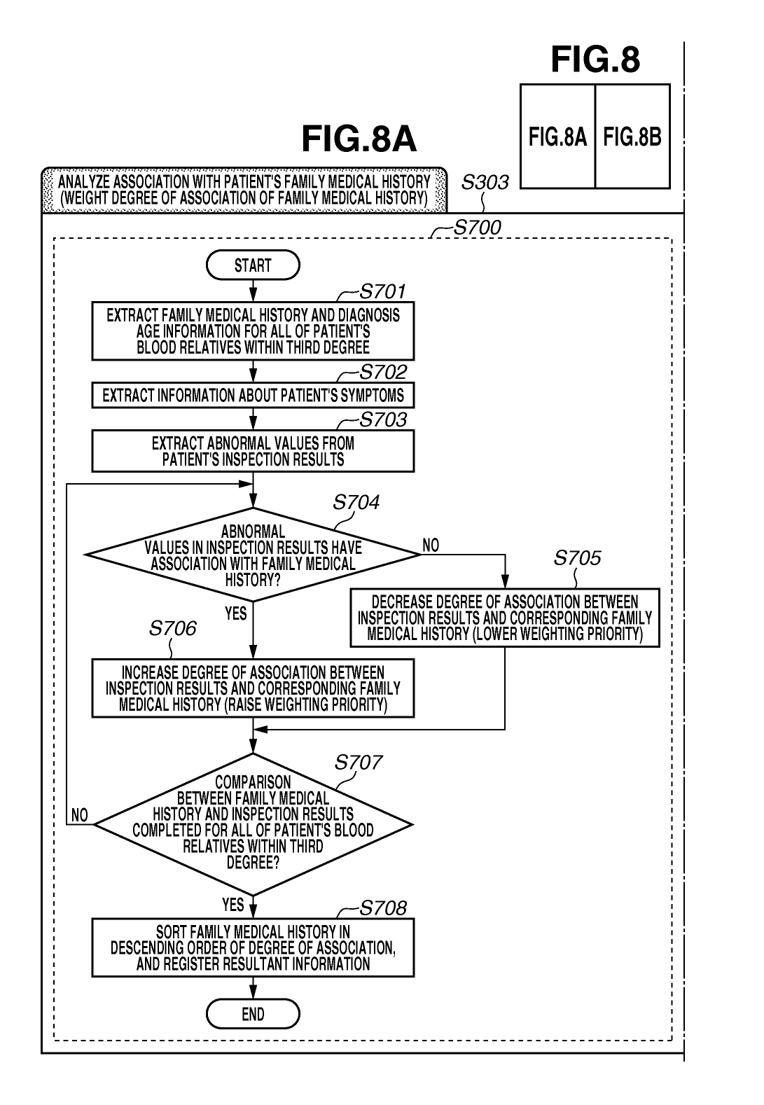

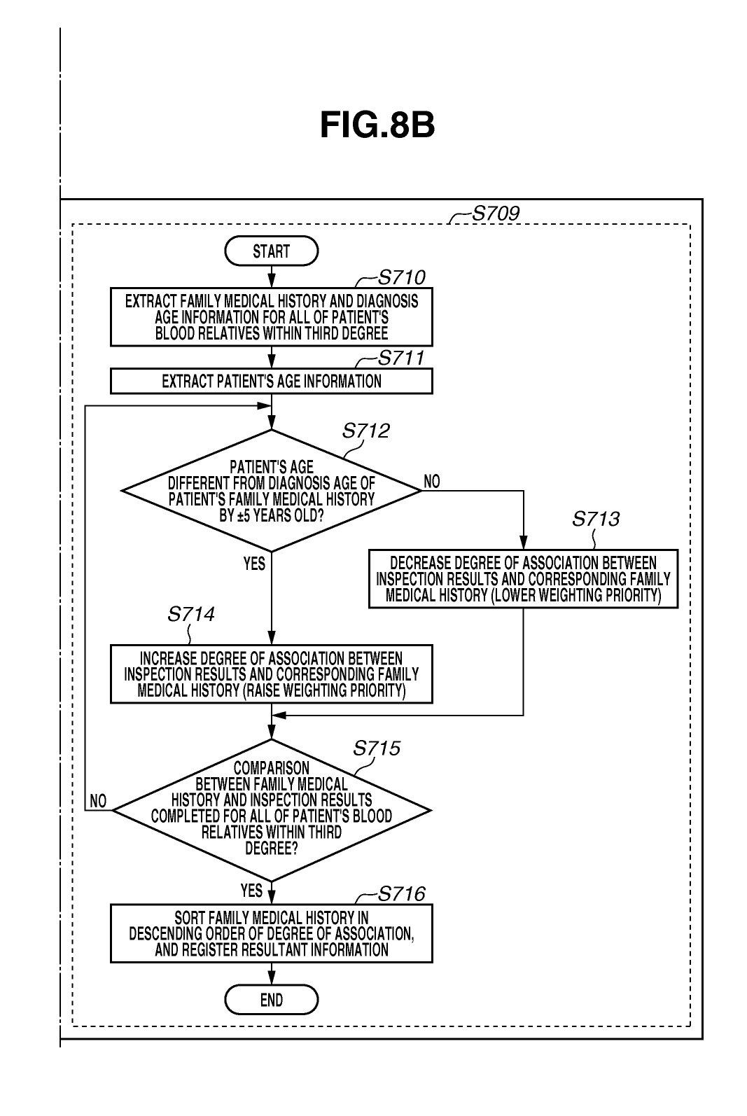

In step S303, the information management unit 108 analyzes information regarding a target patient from the medical information acquired in steps S301 and S302. Processing in step S303 will be described in detail below with reference to FIG. 8.

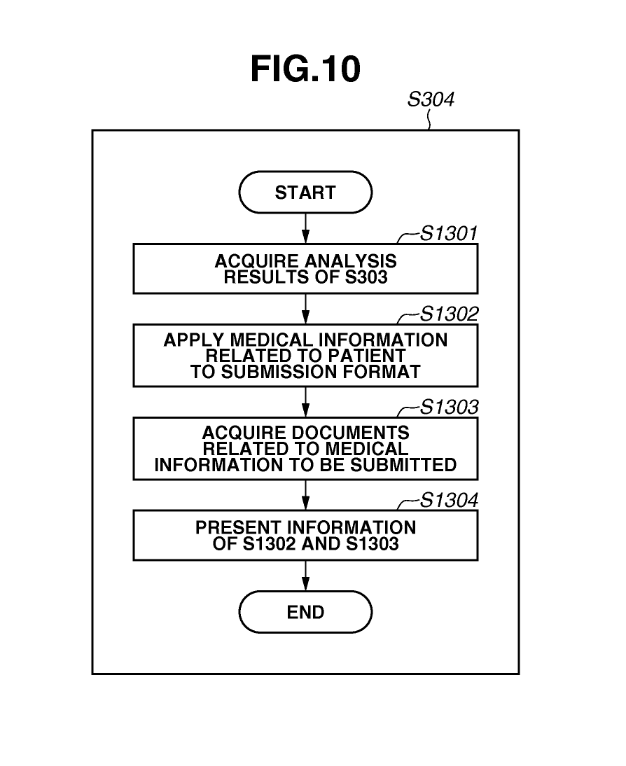

In step S304, the information management unit 108 generates analysis results based on the results of the analysis processing in step S303. The control unit 107 displays on the display unit 110 the analysis results generated by the information management unit 108 (display control). Processing in step S304 will be described in detail below with reference to FIG. 10.

As a result of the processing in steps S301 to S304, various medical information regarding the patient's family medical history is displayed on the display unit 110 of the medical information analysis processing unit 105.

FIG. 4 is a flowchart illustrating the processing in step S301.

In step S501, the medical information acquisition unit 201 receives a patient selection operation by a user of the medical information analysis processing apparatus 105, i.e., a medical staff. The medical staff inputs a patient identification (ID) number and a patient name, for example, from a search box in a graphical user interface to specify a patient. The medical staff may also specify a patient from the command line. In response to the patient selection operation by the medical staff, the medical information acquisition unit 201 acquires identification information for identifying the specified patient.

In step S502, the medical information acquisition unit 201 acquires from the HIS 102, the RIS 103, and the PACS 104 the medical information of the patient identified by the identification information acquired in step S501. More specifically, based on the patient's identification information, the medical information acquisition unit 201 acquires patient information (including patient name, date of birth, and gender) and patient attribute information (including diagnostic results, inspection results, and special affairs) as medical information. The medical information acquisition unit 201 tags the acquired medical information, and classifies the medical information on an item basis.

In step S503, the medical information acquisition unit 201 temporarily registers the patient's medical information acquired in step S502. When registering the medical information, the medical information acquisition unit 201 classifies and registers the medical information (stores the information in the memory) based on the tag information supplied in step S502.

The patient's medical information is acquired by the above-described processing in steps S501 to S503.

FIG. 5 is a flowchart illustrating the processing in step S302.

In step S601, based on the patient's medical information acquired in step S301 illustrated in FIG. 3, the analysis information extraction unit 202 acquires the medical information of the patient's blood relatives from the HIS 102, the RIS 103, and the PACS 104. For example, the information storage unit 109 stores a table for associating a patient's ID with relatives' IDs. The analysis information extraction unit 202 identifies the patient's ID and relatives' IDs based on the table stored in the information storage unit 109. Based on the relatives' IDs, the analysis information extraction unit 202 acquires the medical information of the patient's blood relatives from the HIS 102, the RIS 103, and the PACS 104. The analysis information extraction unit 202 may acquire the medical information of the patient's blood relatives from the cloud 112.

Similar to step S301, the analysis information extraction unit 202 acquires the patient information and the patient attribute information of blood relatives as the medical information of the patient's blood relatives illustrated in FIG. 3. The processing in step S601 may also be executed by the medical information acquisition unit 201. The analysis information extraction unit 202 may acquire the medical information of the patient's blood relatives based on the information regarding the association between the patient and the patient's blood relatives included in the patient information. Further, for example, if genealogy information is registered in the HIS 102, the analysis information extraction unit 202 may trace the patient's blood relatives based on the genealogy information to acquire the medical information of the patient's blood relatives. For example, the genealogy information includes information in which the patient's ID is associated with relatives' IDs.

Although, in the above-described example, the medical information of the patient's blood relatives is acquired based on the information in which the patient's ID is associated with relatives' IDs, the processing is not limited thereto. Since the patient's ID or name is associated with the relatives' names, the medical information of the patient's blood relatives may be acquired by using the relatives' names as a keyword.

In step S602, the analysis information extraction unit 202 extracts information corresponding to the patient's family medical history from among the medical information of the patient's blood relatives acquired in step S601. The family medical history includes a clinical history of the patient's family and relatives.

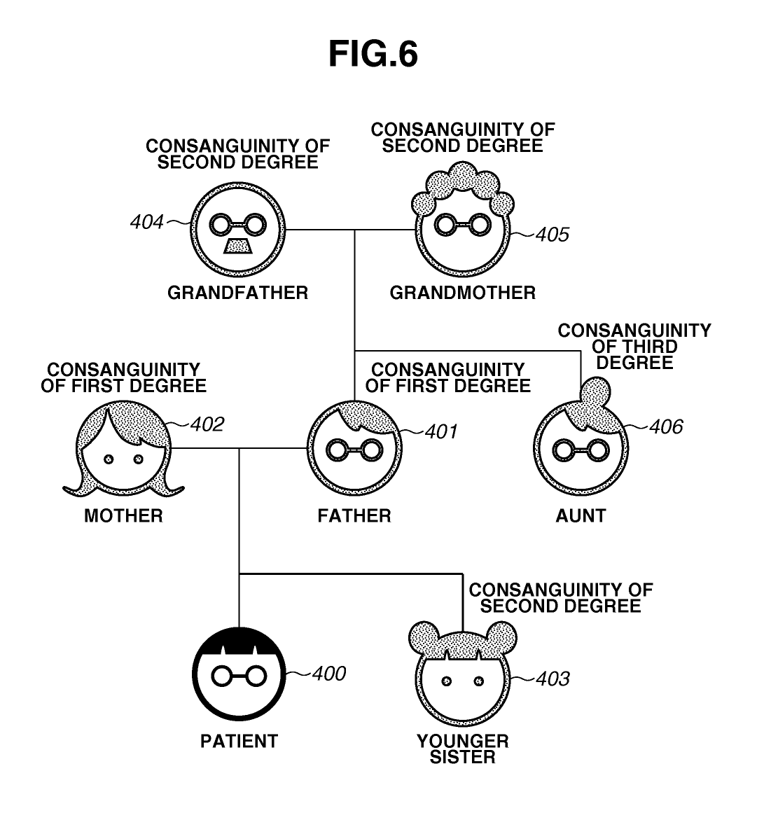

FIG. 6 illustrates the patient's genealogy. Referring to the example illustrated in FIG. 6, relatives of a patient (relevant patient) 400 include a patient's mother 402 and a patient's father 401 as first-degree blood relatives, a patient's younger sister 403, a patient's grandfather 404, and a patient's grandmother 405 as second-degree blood relatives, and a patient's aunt 406 as a third-degree blood relative. Although the genealogy in FIG. 6 illustrates blood relatives within the third degree, relatives are not limited thereto. The analysis information extraction unit 202 extracts, for example, blood relatives within a range of degrees of consanguinity set in the memory. According to the clinical history of the patient's blood relatives illustrated in FIG. 6, the patient's father 401 has diabetes, the patient's mother 402 has hypertension and breast cancer, the patient's grandfather 404 has diabetes, the patient's grandmother 405 has hemophilia, and the patient's aunt 406 has allergosis. In this case, the analysis information extraction unit 202 extracts the association with the patient, disease name, details of diagnosis, and other medical information which may highly likely influence the health of the relevant patient, tags the acquired medical information based on the association with the patient, and classifies the information on an item basis.

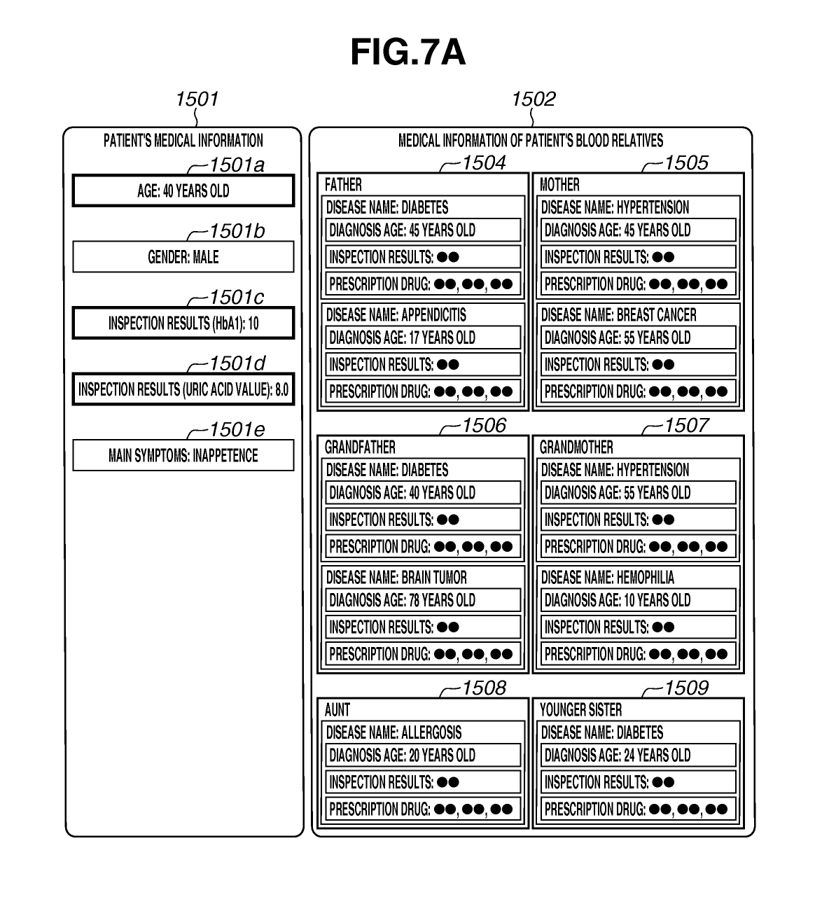

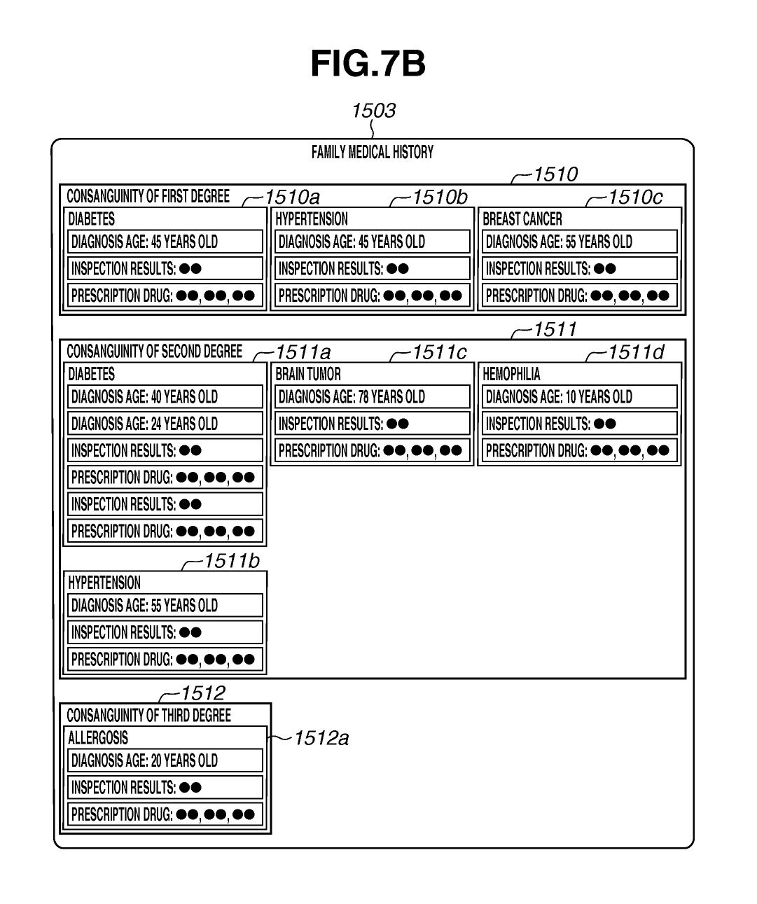

A more specific example of this processing will be described below with reference to FIGS. 7A and 7B.

FIGS. 7A and 7B illustrate an example of medical information extraction processing.

A patient's medical information list 1501 is acquired from the HIS 102, the RIS 103, and the PACS 104. More specifically, patient's medical information (age) 1501a, patient's medical information (gender) 1501b, patient's medical information (inspection results: hemoglobin A1c) 1501c, patient's medical information (inspection results: uric acid value) 1501d, and patient's medical information (main symptoms) 1501e are acquired. These pieces of information are acquired by the processing in step S502.

A patient's blood relatives medical information list 1502 is acquired from the HIS 102, the RIS 103, and the PACS 104 similar to the patient's medical information list 1501. More specifically, patient's father's medical information 1504, patient's mother's medical information 1505, patient's grandfather's medical information 1506, patient's grandmother's medical information 1507, patient's aunt's medical information 1508, and patient's younger sister's medical information 1509 are acquired. These pieces of information are acquired by the processing in step S602.

A patient's family medical history list 1503 tags each piece of the patient's blood relatives medical information list 1502 for each degree of consanguinity. More specifically, a first-degree family medical history list 1510 includes first-degree family's diabetic information 1510a which includes medical information 1504 about the patient's father (a first-degree family). Similarly, a second-degree family medical history list 1511 includes second-degree family's diabetic information 1511a which includes the patient's grandfather's medical information 1506 and the patient's younger sister's medical information 1509. These pieces of information are extracted by the processing in step S602. The patient's family medical history list 1503 includes, for example, a clinical history in which the influence of genetic diseases is recognized.

Returning to the flowchart in FIG. 5, in step S603, the analysis information extraction unit 202 registers in the memory the information corresponding to the family medical history extracted in step S602. When registering the family medical history, the analysis information extraction unit 202 classifies the family medical history based on the tag information supplied in step S602.

Thus, patient analysis information regarding the family medical history is extracted by the processing in steps S301 and S601 to S603.

FIG. 8 is a flowchart illustrating the processing in step S303.

As described below, the processing in step S303 includes processing for weighting the degree of association with the patient's family medical history. In the present exemplary embodiment, since the patient's family medical history is acquired at least within the third degree of consanguinity in step S302, a large amount of information comes up. Therefore, to weight the degree of association with the family medical history, the analysis processing unit 203 utilizes the patient's medical information.

More specifically, there are cases where the association of the family medical history is analyzed based on the combination of the patient's main symptoms, complaints, and inspection results, as illustrated in step S700, and a case where the association of the family medical history is analyzed based on the combination of the patient's blood relatives diagnosis ages and the patient's age. The diagnosis age refers to the age at which a patient's blood relative was diagnosed as a patient of a particular disease which may possibly be registered in the family medical history, as illustrated in step S709. The processing in step S700 and the processing in step S709 may be executed in parallel. Alternatively, the processing in step S709 may be executed after execution of the processing in step S700. When the diagnosis ages of the patient's family medical history cannot be acquired, the processing in step S709 does not need to be executed.

In step S700 illustrated in FIG. 8, the analysis processing unit 203 analyzes the association of the patient's family medical history through the processing in steps S701 to S708, and weights the degree of association with the family medical history.

In step S701, with respect to all of the patient's blood relatives within the third degree, the analysis processing unit 203 extracts the family medical history and diagnosis age information from the medical information of the patient's blood relatives acquired in step S601. The diagnosis age information includes, for example, information including the age at which a relative was diagnosed as a patient of a certain disease.

In step S702, the analysis processing unit 203 extracts information regarding the patient's symptoms (discomfort, fever, inappetence, etc.) from the patient's medical information acquired in step S301. Alternatively, the analysis processing unit 203 extracts information regarding the patient's symptoms (discomfort, fever, inappetence, etc.) from the patient's medical information acquired in step S301 based on the above-described medical information of the patient's blood relatives. For example, when “breast cancer” is extracted as the family medical history in step S701, the analysis processing unit 203 extracts information “breast pain” as information about the patient's symptoms related to “breast cancer.”

The following describes an example of specific processing for extracting information regarding the patient's symptoms from the patient's medical information acquired in step S301 based on the medical information of the patient's blood relatives. The medical information analysis processing apparatus 105 prestores a table for associating the disease name with symptoms related to the disease name. Using the family medical history (disease name) extracted in step S701 as a keyword, the analysis processing unit 203 determines whether symptoms associated with the family medical history (disease name) exist in the patient's medical information acquired in step S301. If a symptom associated with the family medical history exists in the patient's medical information, the relevant symptoms are extracted as information regarding the patient's symptoms. The table associating the disease name with symptoms related to the disease name may be a table associating the disease name and symptoms or a table associating the disease name with a keyword such as a region (“breast”, “fever”, “cough”). More specifically, the table may associate “breast pain” with “breast cancer” or associate “breast cancer” with “breast.” When “breast cancer” is associated with “breast”, the analysis processing unit 203 can extract adjectives for “breast” by using a known document analysis method, thus extracting patient's symptoms. In the present exemplary embodiment, the family medical history (disease names) “breast cancer”, “hypertension”, “diabetes”, and “allergosis” are associated with patient's symptoms “breast pain”, “inappetence”, “fever at 37.0 or higher”, and “cough”, respectively. The table configuration is not limited to that according to the present exemplary embodiment, and may be other configurations.

In step S703, the analysis processing unit 203 extracts abnormal values in the patient's inspection results from the patient's medical information acquired in step S301. Alternatively, the analysis processing unit 203 extracts abnormal values in the patient's inspection results from the patient's medical information acquired in step S301 based on the above-described medical information of the patient's blood relatives. For example, when “hypertension” is extracted as the family medical history in step S701, the analysis processing unit 203 extracts “uric acid value: 8.0” as an abnormal value in the patient's inspection results related to “hypertension.”

The following describes an example of specific processing for extracting abnormal values in the patient's inspection results from the patient's medical information acquired in step S301. The medical information analysis processing apparatus 105 prestores a table for associating the disease name with inspection results and information of abnormal values (for example, threshold values) related to the disease name. By using the family medical history (disease name) extracted in step S701 as a keyword, the analysis processing unit 203 checks whether an inspection result associated with the family medical history (disease name) exists in the patient's medical information acquired in step S301. If a symptom associated with the family medical history exists in the patient's medical information and shows an abnormal value, the analysis processing unit 203 extracts the abnormal value as information regarding the patient's symptom. In the present exemplary embodiment, the family medical history or disease names “hypertension” and “diabetes” are associated with inspection results “uric acid value” and “HbA1c”, respectively. Further, threshold values “7.5” and “8.4” are associated with “uric acid value” and “HbA1c”, respectively. The table configuration is not limited to that according to the present exemplary embodiment, and may be another configuration. For example, threshold values (numerical values) specified herein are only shown as examples and not limited thereto. Further, an abnormal value may be equal to or larger than a predetermined threshold value, or may be a neighbor value of the predetermined threshold value. More specifically, in the present exemplary embodiment, since the uric acid value is 8.0 and is a neighbor value of the threshold value 7.5, the analysis processing unit 203 extracts the uric acid value as an abnormal inspection result.

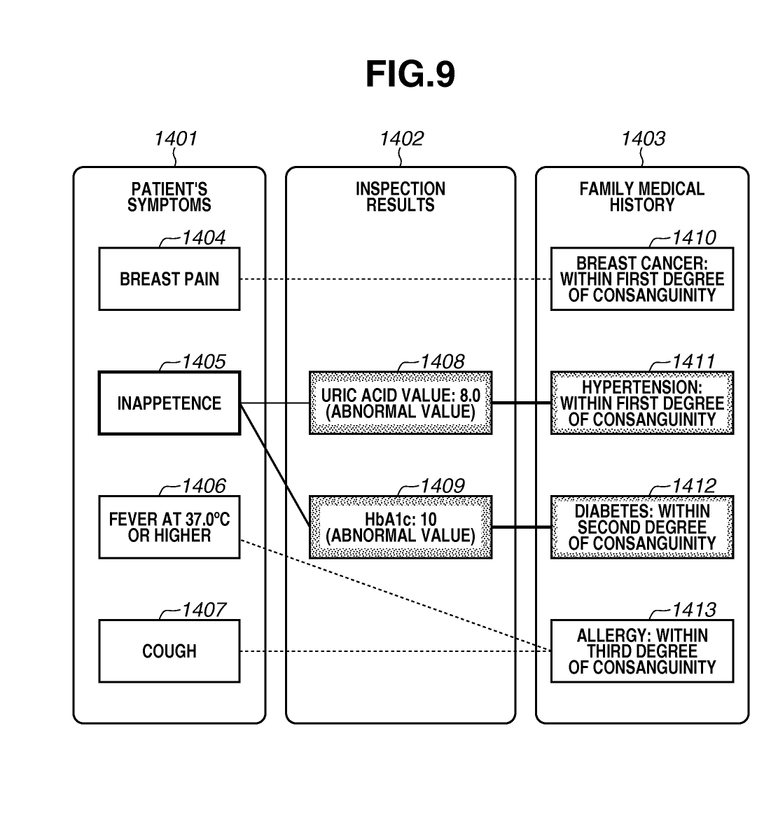

When the patient's symptoms and inspection results are extracted based not on the family medical history in steps S702 and 703, then in step S704, the analysis processing unit 203 determines whether there is an association between the abnormal values in the inspection results and the family medical history, based on the information extracted in steps S701 to S703. For example, by using the table described in steps S702 and S703, the analysis processing unit 203 determines whether there is an association between the patient's symptom and the family medical history and whether there is an association between the inspection results and the family medical history. Based on these two associations, it is possible to acquire an association between the patient's symptoms, the inspection results, and the family medical history, as illustrate in FIG. 9.

When the patient's symptoms and the inspection results are extracted based on the family medical history in step S702 and 703, the analysis processing unit 203 is able to acquire an association between the patient's symptoms, the inspection results, and the family medical history, as illustrated in FIG. 9, by using the extraction results acquired in steps S702 and 703. For example, since “inappetence” and “uric acid value: 8.0” are associated with “hypertension”, “inappetence” is associated with “uric acid value: 8.0.”

If there is an association between the abnormal values in the inspection results and the family medical history, the analysis processing unit 203 increases the degree of association between the inspection results and the corresponding family medical history. A more specific example is illustrated in FIG. 9.

FIG. 9 illustrates an example of an association of the family medical history. In step S700 illustrated in FIG. 8, the analysis processing unit 203 connects the contents of a patient's symptoms list 1401, a patient's inspection results list 1402, and the patient's family medical history list 1403.

The extraction results acquired in step S702 are registered in the patient's symptoms list 1401. More specifically, a patient's symptom (breast pain) 1404, a patient's symptom (inappetence) 1405, a patient's symptom (fever at 37.0 or higher) 1406, and a patient's symptom (cough) 1407 are registered in the patient's symptoms list 1401. Further, the extraction results acquired in step S703 are registered in the patient's inspection results list 1402. More specifically, an example abnormal value (uric acid value) 1408 and an example abnormal value (hemoglobin Alc) 1409 are registered in the patient's inspection results list 1402. The extraction results acquired in step S701 are registered in the patient's family medical history list 1403. More specifically, an example family medical history (breast cancer) 1410, an example family medical history (hypertension) 1411, an example family medical history (diabetes) 1412, and an example family medical history (allergosis) 1413 are registered in the family medical history list 1403.

The information of the patient's symptoms (breast pain) 1404 in the patients symptoms list 1401 relates to and therefore is connected with an example family medical history (breast cancer) 1410 of the patient's family medical history list 1403. The information of the patient's symptom (inappetence) 1405 in the patient's symptoms list 1401 is connected with the example abnormal value (uric acid value) 1408 and the example abnormal value (HbA1c) 1409 in the information in the patient's inspection results list 1402. The example abnormal value (uric acid value) 1408 in the information in the patient's inspection results list 1402 relates to and therefore is connected with an example family medical history (hypertension) 1411. The example abnormal value (hemoglobin A1c) 1409 in the 1402 relates to and therefore is connected with the example family medical history (diabetes) 1412. These connections are acquired based on the table described in steps S702 and S703.

When all of the patient's symptoms list 1401, the patient's inspection results list 1402, and the patient's family medical history list 1403 are connected, the information is processed as information having the highest degree of association. Even if the patient's symptoms are connected with the family medical history but not connected with the inspection results, the information is processed as information having a lower degree of association than the family medical history.

Returning to the descriptions of FIG. 8, when the analysis processing unit 203 determines that there is an association between the abnormal values in the inspection results and the family medical history (YES in step S704), the processing proceeds to step S706. On the other hand, when the analysis processing unit 203 determines that there is no association between the abnormal value in the inspection results and the family medical history (NO in step S704), the processing proceeds to step S705. In step S705, the analysis processing unit 203 lowers the degree of association between the inspection results and the corresponding family medical history (subtracts a predetermined value from the value of the degree of association). On the other hand, in step S706, the analysis processing unit 203 increases the degree of association between the inspection results and the corresponding family medical history (adds a predetermined value to the value of the degree of association). In step S706, if there is an association between the abnormal values in the inspection results, the patient's symptoms, and the family medical history, the degree of association between the family medical history and the patient's symptoms may be higher than the degree of association in the case where there is an association only between the abnormal values in the inspection results and the family medical history. Further, the degree of association may be changed based on the number of degrees of consanguinity related to the family medical history. Referring to the example illustrated in FIG. 9, if there is a first degree blood relative having hypertension as the family medical history and a second degree blood relative having diabetes, the degree of association between the family medical history and hypertension may be made higher than the degree of association between the family medical history and diabetes.

In step S707, the analysis processing unit 203 determines whether the comparison between the family medical history and the inspection results is completed for all of the patient's blood relatives within the third degree. If the comparison between the family medical history and the inspection results is not completed for all of the patient's blood relatives within the third degree (NO in step S707), the analysis processing unit 203 repeats processing from step S704. On the other hand, if the relevant comparison is completed (YES in step S707), the processing proceeds to step S708. When the comparison is completed (YES in step S707), in the example illustrated in FIG. 9, the degree of association between the family medical history and “hypertension” and that between the history and “diabetes” are determined to be higher than the degree of association between the family medical history and “breast cancer” and that between the history and “allergosis”.

In step S708, based on the degree of association weighted in steps S704 to S707, the analysis processing unit 203 sorts out the family medical history in descending order of the degree of association, and registers the resultant family medical history information in a memory.

In step S709 illustrated in FIG. 8, the analysis processing unit 203 analyzes the association of the patient's family medical history in processing in steps S710 to S715, and weights the degree of association of the family medical history.

In step S710, with respect to all of the patient's blood relatives within the third degree, the analysis processing unit 203 extracts the patient's family medical history and diagnosis age information from the medical information of the patient's blood relatives acquired in step S601. Processing in step S710 is similar to the processing in step S701. Therefore, when the processing in step S709 is executed following step S700, the processing in step S710 may be replaced with the processing in step S701.

In step S711, the analysis processing unit 203 extracts the patient's age information from the patient's medical information acquired in step S301.

In step S712, the analysis processing unit 203 compares the diagnosis age information extracted in step S710 with the parent's age information extracted in step S711 to determine whether the difference between the two ages is ±5 years old or less. When the age difference is ±5 years old or less (YES in step S712), the processing proceeds to step S714. On the other hand, when the relevant age difference exceeds ±5 years old (NO in step S712), the processing proceeds to step S713. The age difference is not limited to ±5 years old or less, and may be other values. More specifically, ±5 years old is only an example of a predetermined range.

In step S713, the analysis processing unit 203 decreases the degree of association between the inspection results and the corresponding family medical history (lowers the weight of the association degree between the inspection results and the family medical history). On the other hand, in step S714, the analysis processing unit 203 increases the degree of association between the inspection results and the corresponding family medical history (raises the weight of the association degree between the inspection results and the family medical history). For example, if the diagnosis age of diabetes is 50 as the family medical history and the patient's age is 48, the analysis processing unit 203 increases the degree of association between the family medical history and diabetes. Further, if the diagnosis age of allergosis is 80 as the family medical history and the patient's age is 48, the analysis processing unit 203 decreases the degree of association between the family medical history and allergosis.

In step S715, the analysis processing unit 203 determines whether the comparison between the family medical history and the inspection results is completed for all of the patient's blood relatives within the third degree. If the comparison between the family medical history and the inspection results is not completed for all of the patient's blood relatives within the third degree (NO in step S715), the analysis processing unit 203 repeats the processing from step S712. On the other hand, if the comparison is completed for all of the patient's blood relatives within the third degree (YES in step S715), the processing proceeds to step S716.

In step S716, based on the degree of association weighted in steps S712 to S715, the analysis processing unit 203 sorts out the family medical history in descending order of association, and registers the resultant family medical history information in a memory. In step S716, the analysis processing unit 203 performs sorting-out similar to step S708. The analysis processing unit 203 may perform sorting-out separately or collectively at once. When performing sorting-out collectively at once, the analysis processing unit 203 sorts out the family medical history by using a first degree of association calculated in steps S701 to S707 and a second degree of association calculated in steps S710 to S715. The first degree of association and the second degree of association may be simply summed or weighted. For example, with respect to diseases which are likely to depend on age, such as breast cancer, the weight for the second degree of association may be made larger than that for the first degree of association. Conversely, with respect to diseases which are unlikely to depend on age, the weight for the first degree of association may be made larger than that for the second degree of association.

FIG. 10 is a flowchart illustrating the processing in step S304.

In step S1301, the analysis results generation unit 204 acquires the association of the patient's family medical history as results of the analysis in step S303. More specifically, the analysis results generation unit 204 acquires the degree of association of the family medical history. The analysis results generation unit 204 further acquires the medical information of the patient's blood relative acquired in step S601 and the patient's medical information acquired in step S301.

In step S1302, the analysis results generation unit 204 applies the medical information such as the patient's family medical history acquired in step S1301 to a presentation format. When the analysis results generation unit 204 applies the medical information to the presentation format, the analysis results generation unit 204 performs certain processing, for example, it changes the presentation order of information about the family medical history in which the order of the family medical history registered in steps S708 and S716 is reflected, or hides a part of the personal information of the patient's blood relatives. As a more specific example of processing for hiding a part of the personal information, when presenting information of the patient's grandfather 404 illustrated in FIG. 6, a description of the grandfather is not directly given but a blood relative within the second degree is given. The personal information of the patient's blood relatives can be protected in this way. However, it is not required to perform processing for hiding a part of the personal information. Further, the analysis results generation unit 204 may determine whether to perform processing for hiding the name of a patient's blood relative depending on the disease name.

In step S1303, the analysis results generation unit 204 acquires support documentation for medical information such as the patient's family medical history acquired in step S1301. For example, when a diabetic is included in medical information such as the patient's family medical history, the analysis results generation unit 204 acquires a document related to diabetes. The analysis results generation unit 204 may acquire a document from other apparatuses communicably connected via the network 100. The processing may proceed to step S1304 from step S1302 without executing step S1303.

In step S1304, the analysis results generation unit 204 or the control unit 107 which has received an instruction from the analysis results generation unit 204 displays on the display unit 110 the presentation format to which the medical information is applied in step S1302 and the document acquired in step S1303, as analysis results.

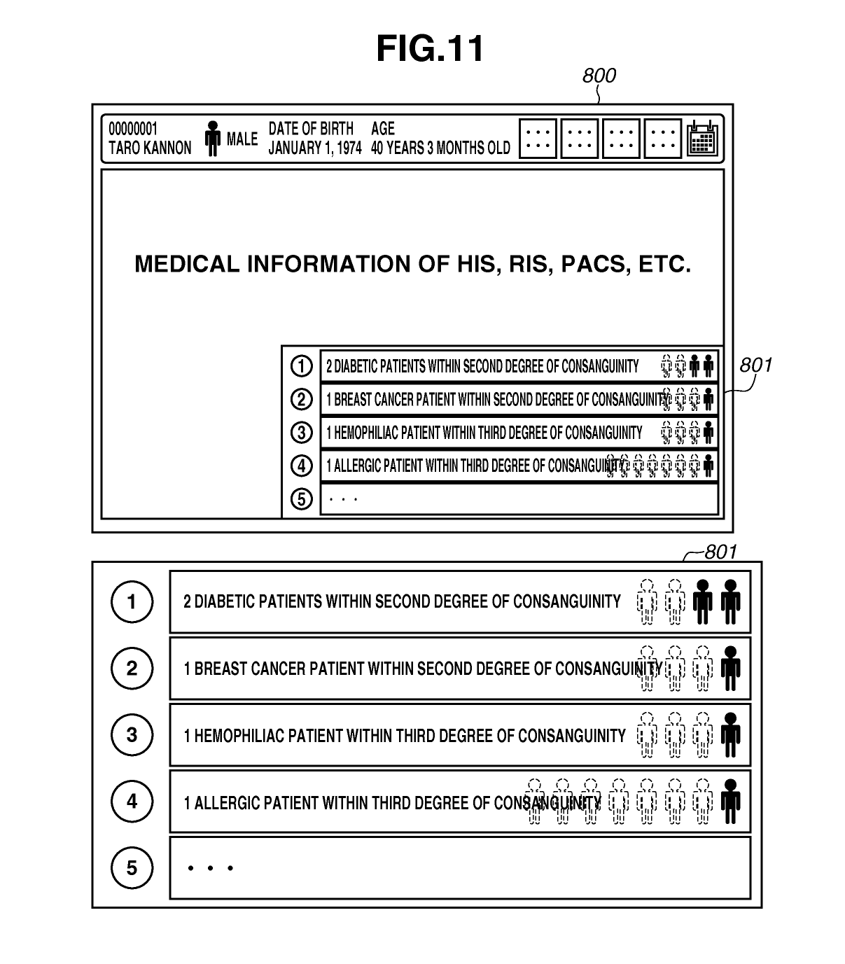

FIG. 11 illustrates an example of a screen for displaying results of analysis by the medical information analysis processing unit 105.

A screen 800 illustrated in FIG. 11 displays the overall patient's medical information. The information displayed on the screen 800 is a patient's medical information including the patient's basic information (patient name, age, date of birth, etc.), the patient's life image, a clinical history, physical exam findings, inspection results, and Simple Object Access Protocol (SOAP). These pieces of information are acquired from the HIS 102, the RIS 103, and the PACS 104 in step S301.

An analysis result presentation area 801 illustrated in FIG. 11 is an area for presenting analysis results presented in step S304 of FIG. 3. In this example, information of the family medical history sorted out in descending order of the degree of association with the patient is presented as analysis results. More specifically, information of the family medical history having the highest degree of association is presented at the top of the list. In the analysis result presentation area 801 of the family medical history, the control unit 107 hides a part of the personal information of the patient's blood relatives (the association between the patient and the relatives) from the viewpoint of private information protection.

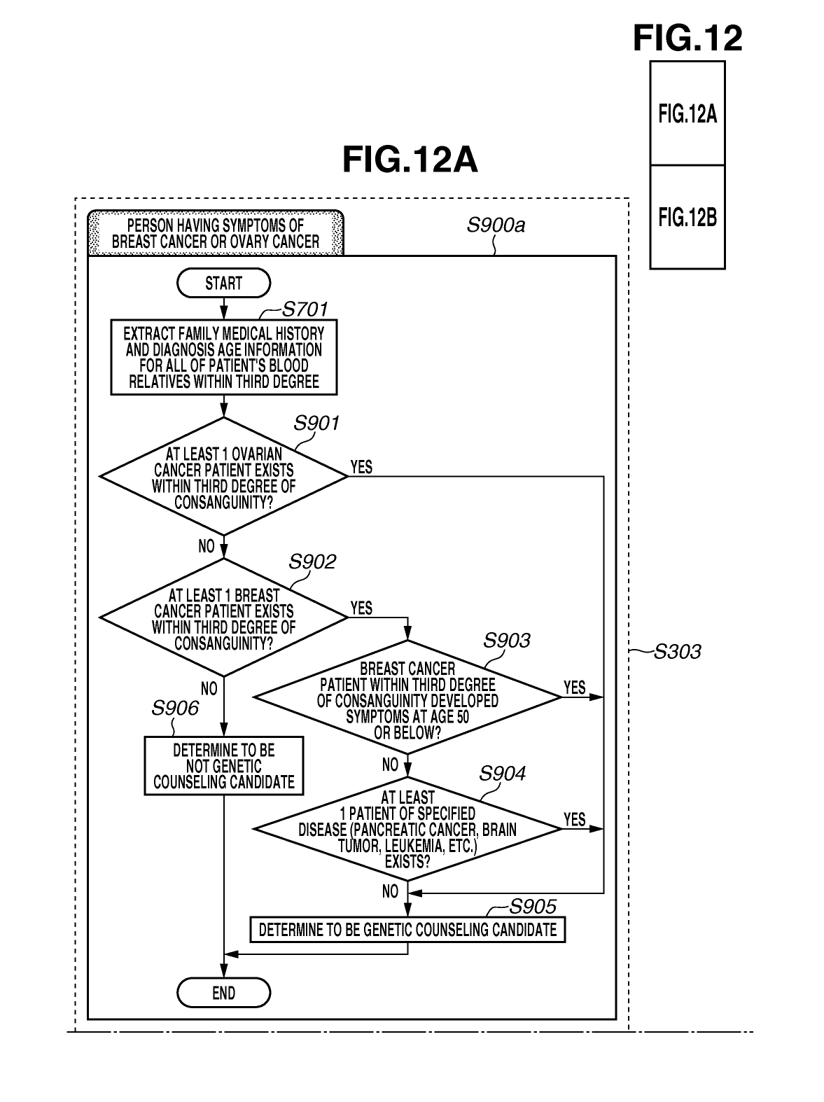

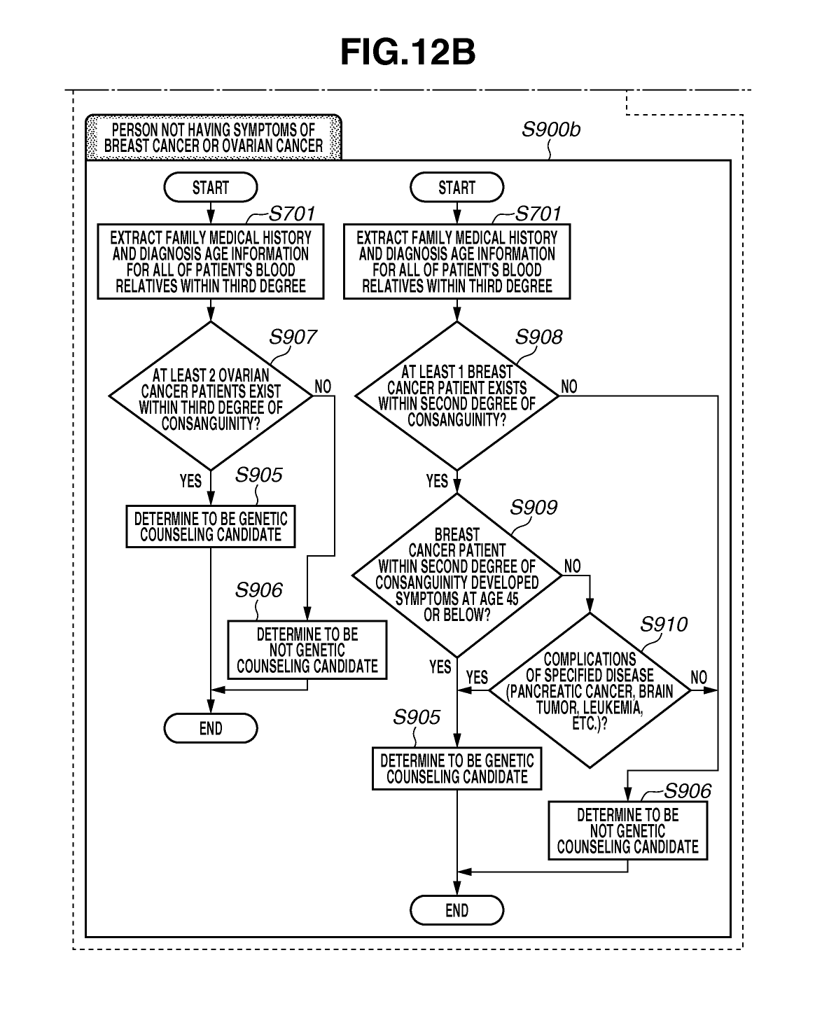

A second exemplary embodiment will be described below. FIG. 12 is a flowchart illustrating the processing in step S303.

Step S900a illustrated in FIG. 12 is processing for determining whether the patient diagnosed to have symptoms of breast cancer or ovarian cancer is a genetic counseling candidate.

Step S900b is processing for determining whether the patient diagnosed not to have symptoms of breast cancer or ovarian cancer is a genetic counseling candidate. Based on the patient's medical information acquired in step S301, the analysis processing unit 203 determines whether the patient was diagnosed to have symptoms of breast cancer or ovarian cancer or diagnosed not to have symptoms of breast cancer or ovarian cancer, and the processing is divided into branches. More specifically, based on the result of the above-described determination, the analysis processing unit 203 determines whether to perform the processing in step S900a or the processing in step S900b as described below.

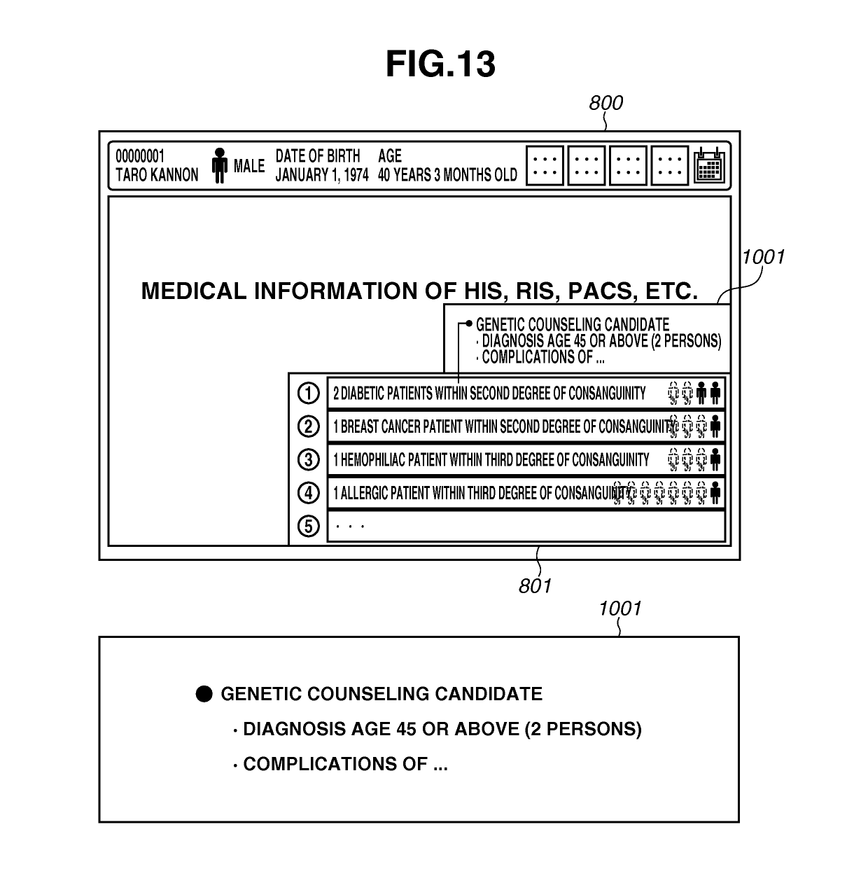

The processing illustrated in FIG. 12 may be performed after completion of the processing illustrated in FIG. 8, or may be performed independently of the processing illustrated in FIG. 8. When the processing illustrated in FIG. 12 is performed after completion of the processing illustrated in FIG. 8, as illustrated in FIG. 13 (described below), the analysis result presentation area 801 and a warning message presentation area 1001 are displayed on the same screen. On the other hand, when the processing illustrated in FIG. 12 is performed independently of the processing illustrated in FIG. 8, the analysis result presentation area 801 is not displayed, and the warning message presentation area 1001 is displayed on the screen.

In the case of step S900a illustrated in FIG. 12, in step S701, with respect to all of the patient's blood relatives within the third degree, the analysis processing unit 203 extracts the family medical history and diagnosis age information from the medical information of the patient's blood relatives acquired in step S601. In this case, if the processing in step S700 has already been performed, the processing in step S701 in step S900a may be replaced with the processing in step S701 in step S700.

In step S901, based on the above-described extracted information, the analysis processing unit 203 determines whether there is at least one ovarian cancer patient within the third degree of consanguinity. If there is at least one ovarian cancer patient within the third degree of consanguinity (YES in step S901), the processing proceeds to step S905. On the other hand, if there is no ovarian cancer patient within the third degree of consanguinity (NO in step S901), the processing proceeds to step S902.

In step S902, based on the above-described extracted information, the analysis processing unit 203 determines whether there is at least one breast cancer patient within the third degree of consanguinity. If there is at least one breast cancer patient within the third degree of consanguinity (YES in step S902), the processing proceeds to step S903. On the other hand, if there is no breast cancer patient within the third degree of consanguinity (NO in step S902), the processing proceeds to step S906.

In step S903, based on the above-described extracted information, the analysis processing unit 203 determines whether the blood relative diagnosed as a breast cancer patient within the third degree developed the symptoms of breast cancer at age 50 or below. When the blood relative diagnosed as a breast cancer patient within the third degree developed the symptoms of breast cancer at age 50 or below (YES in step S903), the processing proceeds to step S905. On the other hand, when the blood relative diagnosed as a breast cancer patient within the third degree did not develop the symptoms of breast cancer at age 50 or below (NO in step S903), the processing proceeds to step S904.

In step S904, based on the above-described extracted information, the analysis processing unit 203 determines whether there is at least one patient of specified diseases (pancreatic cancer, brain tumor, leukemia, etc.) in addition to the breast cancer patient.

In step S905, the analysis processing unit 203 determines the patient to be a genetic counseling candidate. On the other hand, in step S906, the analysis processing unit 203 determines the patient to be not a genetic counseling candidate.

Next, the processing of the two flowcharts in step S900b is described. The processing in step S900b illustrated in FIG. 12 may be performed in parallel. Alternatively, the processing in step S900b may be sequentially performed, for example, one processing is performed first and then another processing may be performed.

First, processing of the flowchart on the left-hand side will be described below.

In step S701, with respect to all of the patient's blood relatives within the third degree, the analysis processing unit 203 extracts the patient's family medical history and diagnosis age information from the medical information of the patient's blood relatives acquired in step S601. In this case, if the processing in step S700 has already been performed, the processing in step S701 in step S900a may be replaced with the processing in step S701 in step S700. Similarly, if the processing in step S900a has already been performed, the processing in step S701 of the flowchart on the left-hand side in step S900b may be replaced with the processing in step S701 in step S900a. Further, if processing of either one of the two flowcharts in step S900b is to be executed first, the processing in step S701 may be similar to the processing of the flowchart executed first.

In step S907, based on the above-described extracted information, the analysis processing unit 203 determines whether there are at least two ovarian cancer patients within the third degree of consanguinity. When there are at least two ovarian cancer patients within the third degree of consanguinity (YES in step S907), the processing proceeds to step S905. On the other hand, if there are not at least two ovarian cancer patients within the third degree of consanguinity (NO in step S907), the processing proceeds to step S906.

The processing in steps S905 and S906 is similar to the above-described processing.

The processing of the flowchart on the right-hand side will be described below.

In step S701, with respect to all of the patient's blood relatives within the third degree, the analysis processing unit 203 extracts the family medical history and diagnosis age information from the medical information of the patient's blood relatives acquired in step S601. In this case, if the processing in step S700 has already been performed, the processing in step S701 in step S900a may be replaced with the processing in step S701 in step S700. Similarly, if the processing in step S900a has already been performed, the processing in step S701 of the flowchart on the right-hand side in step S900b may be replaced with the processing in step S701 in step S900a. Further, if processing of either one of the two flowcharts in step S900b is to be executed first, the processing in step S701 may be similar to the processing of the flowchart executed first.

In step S908, based on the above-described extracted information, the analysis processing unit 203 determines whether there is at least one breast cancer patient within the second degree of consanguinity. If there is at least one breast cancer patient within the second degree of consanguinity (YES in step S908), the processing proceeds to step S909. On the other hand, if there is no breast cancer patient within the second degree of consanguinity (NO in step S908), the processing proceeds to step S906.

In step S909, based on the above-described extracted information, the analysis processing unit 203 determines whether the breast cancer patient within the second degree of consanguinity developed the symptoms at age 45 or below. If the breast cancer patient within the second degree of consanguinity developed the symptoms at age 45 or below (YES in step S909), the processing proceeds to step S905. On the other hand, if the breast cancer patient within the second degree of consanguinity did not develop the symptoms at age 45 or below (NO in step S909), the processing proceeds to step S910. In step S910, based on the above-described extracted information, the analysis processing unit 203 determines whether the patient has any complication of the specified diseases (pancreatic cancer, brain tumor, leukemia, etc.). If the patient has any complication of the specified diseases (pancreatic cancer, brain tumor, leukemia, etc.) (YES in step S910), the processing proceeds to step S905. On the other hand, if the patient has no complication of the specified diseases (pancreatic cancer, brain tumor, leukemia, etc.) (NO in step S910), the processing proceeds to step S906.

Processing in steps S905 and S906 is similar to the above-described processing.

FIG. 13 illustrates an example of a screen for displaying results of analysis by the medical information analysis processing unit 105.

The warning message presentation area 1001 for the genetic counseling candidate presents a ground for the determination that the patient is a genetic counseling candidate. More specifically, as described above, if any patient's blood relative has a previous history of particular diseases such as breast cancer and diabetes, and if the diagnosis age of the blood relative is close to the patient's age, the patient is determined to be a genetic counseling candidate, and the ground for the determination is presented. Therefore, the warning message presentation area 1001 presents a message recommending genetic counseling and a reason of recommendation, such as “Diagnosis Age 45 of Specified Diseases (Diabetes, etc.)” and “Complications of Specified Diseases (Brain Tumor, etc.)

Further, in order to improve visibility, the control unit 107 may adjust the amount of descriptions of the message in the warning message presentation area 1001 according to a user's operation. For example, the message may be short sentences or itemized statements, or long sentences describing detailed matters.

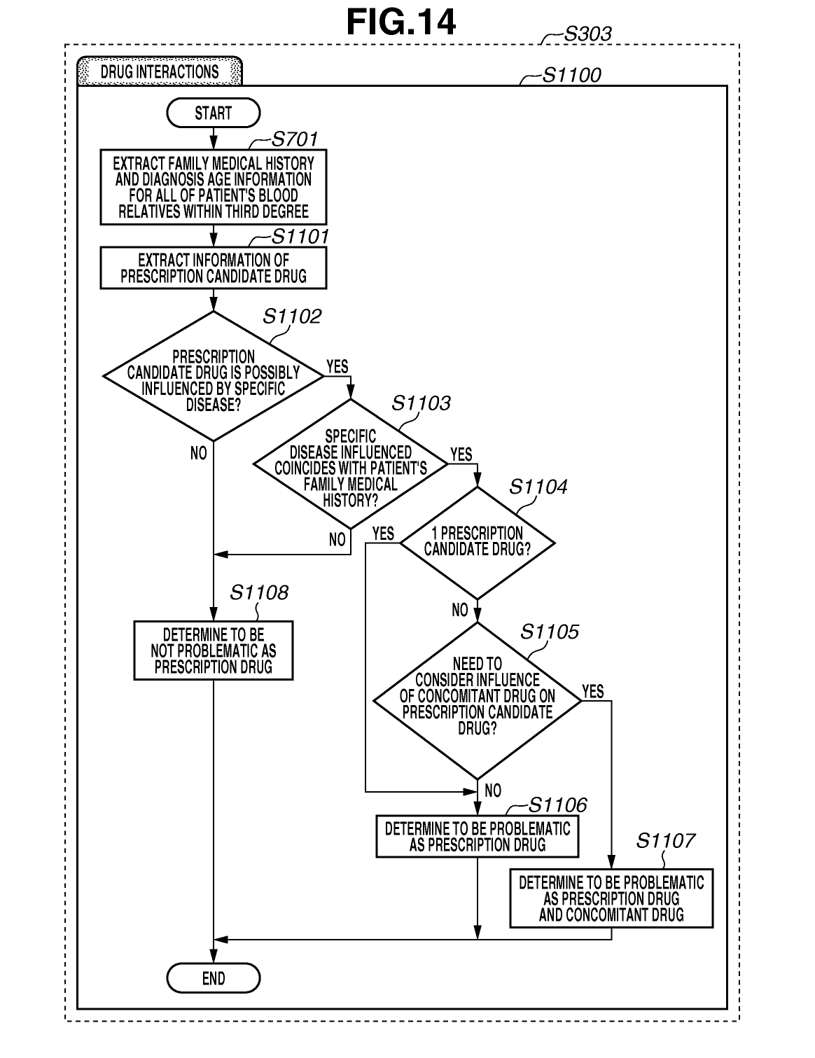

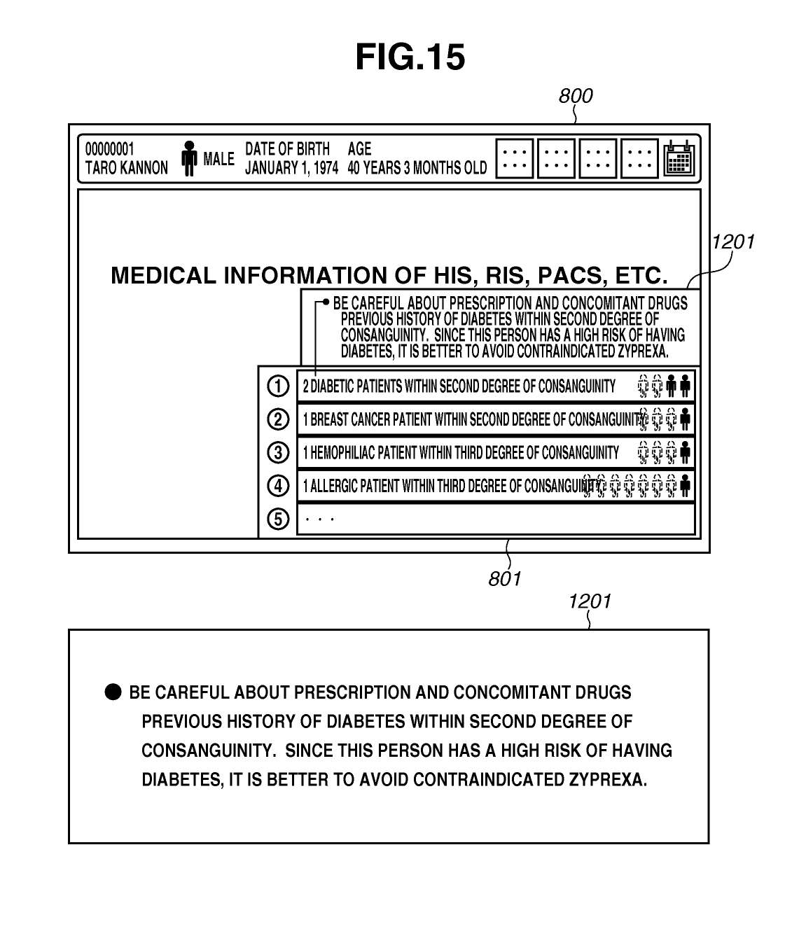

A third exemplary embodiment will be described below. FIG. 14 is a flowchart illustrating the processing in step S303. Processing illustrated in FIG. 14 may be performed after completion of the processing illustrated in FIG. 8 (FIGS. 8 and 12) or performed independently of the processing illustrated in FIG. 8. When the processing illustrated in FIG. 14 is performed after completion of the processing illustrated in FIG. 8, the analysis result presentation area 801 and the warning message presentation area 1201 are displayed on the same screen, as illustrated in FIG. 15 (described below). On the other hand, when the processing illustrated in FIG. 14 is performed independently of the processing illustrated in FIG. 8, the analysis result presentation area 801 is not displayed, but the warning message presentation area 1201 is displayed on the screen.

In step S701, with respect to all of the patient's blood relatives within the third degree, the analysis processing unit 203 extracts the family medical history and diagnosis age information from the medical information of the patient's blood relatives acquired in step S601. As described above, when the processing in step S701 has already been performed by the other flowchart, the processing illustrated in step S701 illustrated in FIG. 14 may be replaced with the processing in step S701 already performed by the other flowchart.

In step S1101, the analysis processing unit 203 extracts information of the patient's prescription candidate drug.

In step S1102, based on the information extracted in steps S701 and S1101, the analysis processing unit 203 determines whether the patient's prescription candidate drug may possibly be influenced by a particular disease. If the patient's prescription candidate drug may possibly be influenced by a particular disease (YES in step S1102), the processing proceeds to step S1103. On the other hand, if the patient's prescription candidate drug may not be influenced by a particular disease (NO in step S1102), the processing proceeds to step S1108.

In step S1103, based on the above-described extracted information, the analysis processing unit 203 determines whether the name of the particular disease influencing the prescription candidate drug coincides with the patient's family medical history. If the name of the particular disease influencing the prescription candidate drug does not coincide with the patient's family medical history (NO in step S1103), the processing proceeds to step S1108. On the other hand, if the name of the particular disease influencing the prescription candidate drug coincides with the patient's family medical history (YES in step S1103), the processing proceeds to step S1104.

In step S1104, based on the information of the patient's prescription candidate drug extracted in step S1101, the analysis processing unit 203 determines whether the number of the patient's prescription candidate drugs is one. If the number of the patient's prescription candidate drugs is one (YES in step S1104), the processing proceeds to step S1106. On the other hand, if the number of the patient's prescription candidate drugs is not one (NO in step S1104), the processing proceeds to step S1105.

In step S1105, based on the information of the above-described patient's prescription candidate drug, the analysis processing unit 203 determines whether the patient is subject to side effects depending on the combination of the prescription candidate drugs. If it is necessary to take into consideration the influence of the concomitant drug on the prescription candidate drugs (YES in step S1105), the processing proceeds to step S1107. On the other hand, if it is not necessary to take into consideration the influence of the concomitant drug on the prescription candidate drugs (NO in step S1105), the processing proceeds to step S1106.

In step S1106, the analysis processing unit 203 determines that the patient's prescription candidate drug is problematic as a prescription drug.

In step S1107, the analysis processing unit 203 determines that the patient's prescription candidate drugs are problematic as prescription and concomitant drugs.

In step S1108, the analysis processing unit 203 determines that the patient's prescription candidate drug is not problematic as a prescription drug.

Thus, relevance of drug interactions is analyzed by the processing illustrated in FIG. 14.

FIG. 15 illustrates an example of a screen for displaying results of analysis by the medical information analysis processing unit 105.

The warning message presentation area 1201 for drug interactions presents the influence of the prescription and concomitant drugs on the patient. More specifically, as described above, the patient 400's father 401 and the patient 400's grandfather 404 illustrated in FIG. 6 have a previous history of diabetes. Therefore, as the patient 400 has a high risk of having diabetes, it is not advisable to recommend the prescription of specific drugs, such as Zyprexa contraindicated for diabetic patients. Therefore, a caution message regarding prescription and concomitant drugs and the reason of caution, for example, “Blood Relatives within Second Degree Have Previous History of Diabetes, and This Patient Has a High Risk of Having Diabetes. It Is Better to Avoid Contraindicated Zyprexa.” is presented.

Further, in order to improve visibility, the control unit 107 may adjust the amount of descriptions of the message in the warning message presentation area 1201 according to a user's operation. For example, the message may be short sentences or itemized statements, or long sentences describing detailed matters.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-080370 filed Apr. 9, 2014, which is hereby incorporated by reference herein in its entirety.

What is claimed is:

1. An information processing apparatus comprising:
a first acquisition unit configured to acquire medical information of a patient;
a second acquisition unit configured to acquire medical information of the patient's blood relatives;
a determination unit configured to determine a degree of association between the patient's symptoms and the patient's family medical history based on the patient's medical information acquired by the first acquisition unit and on the medical information of the patient's blood relatives acquired by the second acquisition unit; and
a display control unit configured to display the family medical history on a display unit based on the degree of association determined by the determination unit.

2. The information processing apparatus according to claim 1, wherein the second acquisition unit acquires medical information of a plurality of the patient's blood relatives, and
wherein the determination unit determines the degree of association between the patient's symptoms and the patient's family medical history based on the patient's medical information acquired by the first acquisition unit and the medical information of the plurality of the patient's blood relatives acquired by the second acquisition unit.

3. The information processing apparatus according to claim 1, wherein, if the determination unit determines that there is an association between the patient's inspection results and the patient's family medical history based on the patient's medical information and the medical information of the patient's blood relatives, a predetermined value is added to the degree of association to increase the degree of association.

4. The information processing apparatus according to claim 1, wherein, if the determination unit determines that there is no association between the patient's inspection results and the patient's family medical history based on the patient's medical information and the medical information of the patient's blood relatives, a predetermined value is subtracted from the degree of association to decrease the degree of association.

5. The information processing apparatus according to claim 1, wherein, if the determination unit determines that the patient's age and the diagnosis age of the patient's family medical history are within a predetermined value based on the patient's medical information and the medical information of the patient's blood relatives, a predetermined value is added to the degree of association to increase the degree of association.

6. The information processing apparatus according to claim 1, wherein, if the determination unit determines that the patient's age and the diagnosis age of the patient's family medical history are not within a predetermined value based on the patient's medical information and the medical information of the patient's blood relatives, a predetermined value is subtracted from the degree of association to decrease the degree of association.

7. The information processing apparatus according to claim 1, wherein the display control unit displays on the display unit the family medical history sorted out in order of the degree of association.

8. The information processing apparatus according to claim 7, wherein the display control unit displays on the display unit the family medical history sorted out from a head of a list in descending order of the degree of association in list form.

9. The information processing apparatus according to claim 1, further comprising:
a first determination unit configured to determine whether the patient is a genetic counseling candidate based on the patient's medical information acquired by the first acquisition unit and the medical information of the patient's blood relatives acquired by the second acquisition unit,
wherein, if the patient is determined to be a genetic counseling candidate by the first determination unit, the display control unit instructs the display unit to display a warning message indicating that the patient is the genetic counseling candidate.

10. The information processing apparatus according to claim 9, wherein the display control unit further instructs the display unit to display the warning message describing a ground of the determination that the patient is a genetic counseling candidate, by the first determination unit.

11. The information processing apparatus according to claim 1, further comprising:
a second determination unit configured to determine whether the patient's prescription candidate drug may possibly be problematic as a prescription drug based on the patient's medical information acquired by the first acquisition unit and the medical information of the patient's blood relatives acquired by the second acquisition unit,
wherein, if the patient's prescription candidate drug is determined to be possibly problematic as a prescription drug by the second determination unit, the display control unit instructs the display unit to display a warning message indicating that the patient's prescription candidate drug may possibly be problematic.

12. The information processing apparatus according to claim 11, wherein the display control unit further instructs the display unit to display the warning message describing a ground for the determination that the patient's prescription candidate drug may possibly be problematic as a prescription drug, by the second determination unit.

13. The information processing apparatus according to claim 11, wherein the second determination unit determines whether the prescription candidate drug may possibly be influenced by a particular disease based on the patient's medical information and the medical information of the patient's blood relatives, and determines whether the patient's prescription candidate drug may possibly be problematic as a prescription drug based on whether the particular disease possibly influencing the prescription candidate drug coincides with the patient's family medical history.

14. The information processing apparatus comprising:
a first acquisition unit configured to acquire medical information of a patient;
a second acquisition unit configured to acquire medical information of the patient's blood relatives;
a determination unit configured to determine whether the patient is a genetic counseling candidate based on the patient's medical information acquired by the first acquisition unit and the medical information of the patient's blood relatives acquired by the second acquisition unit; and
a display control unit configured to, if the patient is determined to be a genetic counseling candidate by the determination unit, instruct a display unit to display a warning message indicating that the patient is the genetic counseling candidate.

15. An information processing apparatus comprising:
a first acquisition unit configured to acquire medical information of a patient;
a second acquisition unit configured to acquire medical information of the patient's blood relatives;
a determination unit configured to determine whether the patient's prescription candidate drug may possibly be problematic as a prescription drug based on the patient's medical information acquired by the first acquisition unit and the medical information of the patient's blood relatives acquired by the second acquisition unit; and
a display control unit configured to, if the patient's prescription candidate drug is determined to possibly be problematic as a prescription drug by the determination unit, instruct a display unit to display a warning message indicating that the patient's prescription candidate drug may possibly be problematic as a prescription drug.

16. An information processing method performed by an information processing apparatus, the method comprising:
firstly acquiring medical information of a patient;
secondly acquiring medical information of the patient's blood relatives;
determining a degree of association between the patient's symptoms and the patient's family medical history based on the patient's medical information acquired by the first acquisition and the medical information of the patient's blood relatives acquired by the second acquisition; and
controlling display to display a family medical history on a display process based on the determined degree of association.

17. An information processing method performed by an information processing apparatus, the method comprising:
firstly acquiring medical information of a patient;
secondly acquiring medical information of the patient's blood relatives;
determining whether the patient is a genetic counseling candidate based on the patient's medical information acquired by the first acquisition and the medical information of the patient's blood relatives acquired by the second acquisition; and
controlling display, if the patient is determined to be a genetic counseling candidate by the determination, to display on a display process a warning message indicating that the patient is the genetic counseling candidate.

18. An information processing method performed by an information processing apparatus, the method comprising:
firstly acquiring medical information of a patient;
secondly acquiring medical information of the patient's blood relatives;
determining whether the patient's prescription candidate drug may possibly be problematic as a prescription drug based on the patient's medical information acquired by the first acquisition and the medical information of the patient's blood relatives acquired by the second acquisition; and
controlling display, if the patient's prescription candidate drug is determined to be possibly problematic as a prescription drug by the determination, to display on a display process a warning message indicating that the patient's prescription candidate drug may possibly be a problematic as a prescription drug.
